(19) United States
(12) Patent Application Publication
(10) Pub. No.: US 2018/0375791 A1
(43) Pub. Date: Dec. 27, 2018

(54) AUTHORIZATION OF VARYING LEVELS OF ACCESS TO A RESOURCE SERVER

(71) Applicant: CA, Inc., New York, NY (US)

(72) Inventors: Mohammed Mujeeb Kaladgi, Bangalore (IN); Kiran Kumar, Bangalore (IN); Manu Tripathi, Bangalore (IN); Aditya Shekhar, Bangalore (IN); Pushpa Rao, Bangalore (IN); Syed Yusuf, Bangalore (IN)

(21) Appl. No.: 15/631,841

(22) Filed: Jun. 23, 2017

(51) Int. Cl. H04L 12/911; H04L 29/08; H04L 12/927

(52) U.S. Cl. CPC H04L 47/821; H04L 67/16; H04L 47/70; G06F 21/335; H04L 47/72; H04L 47/748; H04L 47/741; H04L 47/808

(57) ABSTRACT

Techniques are disclosed relating to authorizing varying levels of access to computer resources. In one embodiment, consider an authorization server, a resource server that includes a resource (for example, a data item), and an application server operable to incorporate the resource into its own functionality. The authorization server may receive information indicative of a grant of access privileges by a user, authorizing the application server to access the resource. The authorization server may be configured to provide the application server with varying levels of access to the resources of the resource server. For example, the authorization server may provision a plurality of access tokens corresponding to the grant of access privileges to the application server. The plurality of access tokens may each be associated with a scope of access and a duration. In various embodiments, the duration of an access token may be based on its corresponding scope of access.

### BACKGROUND

Technical Field

This disclosure relates generally to computer systems that authorize access to resources stored on a resource server.

Description of the Related Art

Resource servers may provide various resources and functionality to an end user. For example, a resource server that stores contact information may provide an end user the ability to access various contacts stored by the resource server or to perform various types of operations provided by the resource server, such as sending messages to contacts. The resource server may protect access to the user's resources, for example by verifying the user's credentials or otherwise authenticating the user's identity prior to providing access to such resources. In some cases, a third-party application may be permitted to utilize one or more resources provided by a resource server. For example, a third-party streaming audio application may allow an end user to share playlists with the end user's contacts stored by the resource server. One standard that facilitates such third-party access is the OAuth 2.0 authorization framework.

### SUMMARY

Techniques are disclosed relating to authorizing varying levels of access to resources of a resource server. In various embodiments, an authorization server may receive information indicative of a grant of access privileges by a user to an application server. For example, in some embodiments, the grant of access privileges may authorize the application server to access resources of the user that are managed by a resource server. The authorization server may provision a plurality of access tokens corresponding to the grant of access privileges to the application server. Further, the authorization server may store authorization information associated with the grant of access privileges. In some embodiments, the authorization information may include, for each of the plurality of access tokens, a particular scope of access to the resources of the user managed by the resource server and a corresponding duration based on the particular scope of access.

The authorization server may, in various embodiments, receive from the resource server an authorization request that corresponds to an access request by the application server to access one or more resources of the user managed by the resource server. In some embodiments, the authorization request may include one or more access tokens. In various embodiments, the authorization server may determine, based on the authorization information, whether to authorize the authorization request. In some embodiments, the determining may include comparing the received one or more access tokens to the plurality of access tokens provisioned by the application server. Further, in response to detecting that the received one or more access tokens match a provisioned access token, the authorization server may determine whether a type of the access request is permitted by the particular scope of the provisioned access token. The authorization server may determine, based on the corresponding duration of the provisioned access token, whether the received one or more access tokens have expired for the type of the access request. Further, the authorization server may send an authorization indication to the resource server.

### BRIEF DESCRIPTION OF THE DRAWINGS

FIG. 1 is a block diagram illustrating an example system for authorizing access to resources of a resource server, according to some embodiments.

FIG. 2 is a block diagram illustrating an example authorization server, according to some embodiments.

FIGS. 3A-3B depict example access tokens, according to some embodiments.

FIG. 4 is a flow diagram illustrating an example method for authorizing varying levels of access to resources of a resource server, according to some embodiments.

FIG. 5 is a flow diagram illustrating an example method for authorizing varying levels of access to resources of a resource server, according to some embodiments.

FIG. 6 is a flow diagram illustrating an example method for authorizing access to a resource server, according to some embodiments.

FIGS. 7A-7D illustrate an example implementation of an application utilizing resources managed by a resource server, according to some embodiments.

FIG. 8 is a block diagram illustrating an example computer system that may be used to implement one or more of the components in a system for authorizing varying levels of access to a resource server, according to some embodiments.

### DETAILED DESCRIPTION

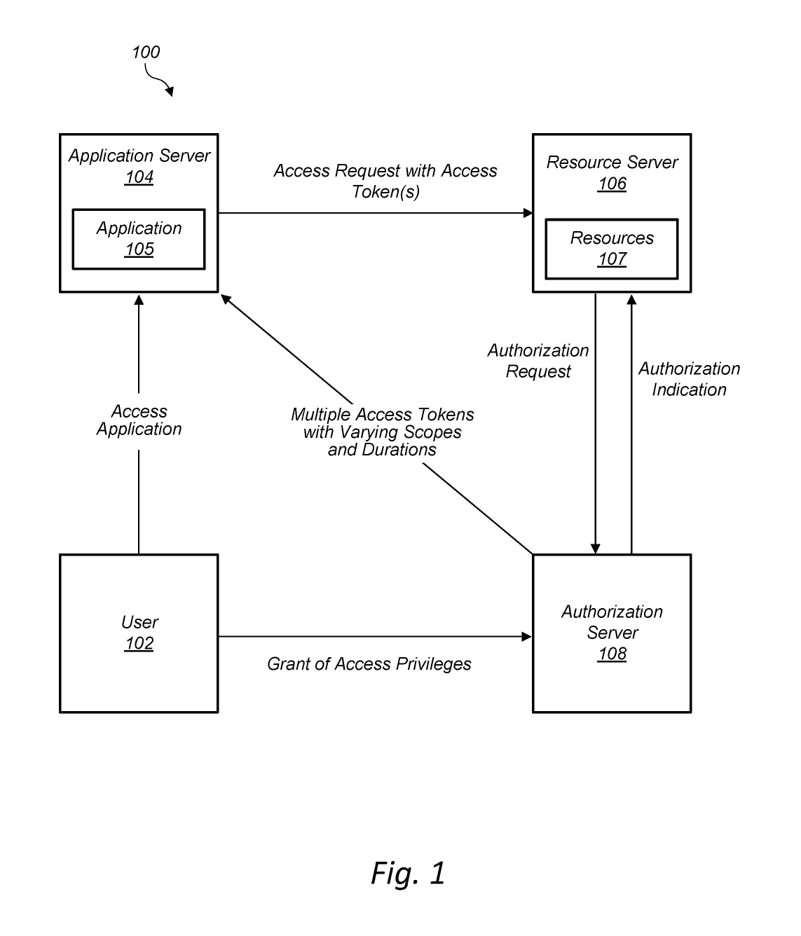

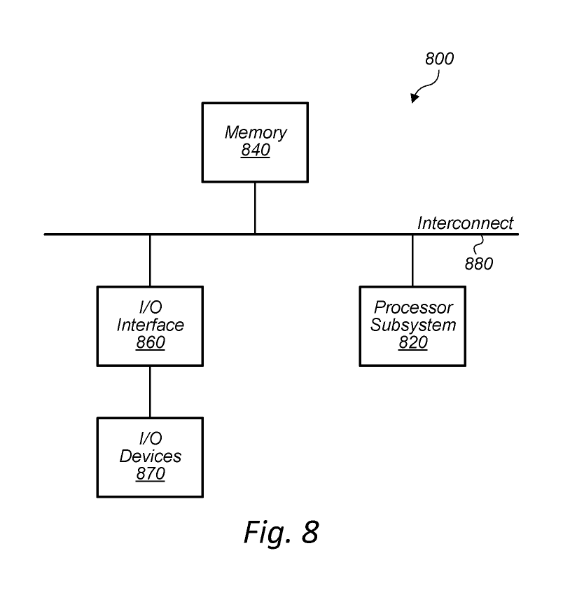

This disclosure describes, with reference to FIGS. 1-7, example systems and methods for authorizing varying levels of access over time to resources of a resource server, according to various embodiments. Finally, an example computer system is described with reference to FIG. 8.

Referring now to FIG. 1, a block diagram illustrating an example system 100 for authorizing access to resources of a resource server is depicted. In the illustrated embodiment, system 100 includes user 102, application server 104, resource server 106, and authorization server 108. Note that, although shown in direct connection, one or more of user 102, application server 104, resource server 106, or authorization server 108 may be connected via one or more communication networks (not shown for clarity).

In various embodiments, authorization server 108 may be configured to provide an application 105 hosted by application server 104 with varying levels of access to one or more resources 107 of resource server 106. The term “resource” is intended to be in interpreted broadly to refer to something that may be provided by a computer to a user—for example, a requested item of data, a result of a function or service, computer code, personal information of the user (e.g., login credentials), etc. In the depicted embodiment, resource server 106 may manage various resources 107 for user 102. In some embodiments, resource server 106 may be an API server operable to service API requests for resources 107 from various applications 105 executing on various application servers 104. For example, in some embodiments, resource server 106 may be a server of a social media service, such as FACEBOOK™, which may provide various resources to user 102, such as storing information (e.g., contact lists, photos, personal information, etc.) for user 102 and providing user 102 with various application functionalities (e.g., messaging, photo sharing, personalized information feed, etc.).

In various embodiments, it may be desired for an application 105 hosted by application server 104 to incorporate one or more resources 107 of the resource server 106 into its own functionality. For example, in one embodiment, application 105 may be a streaming audio provider, such as SPOTIFY™. As part of its functionality, SPOTIFY™ may incorporate various resources provided, for example, by FACEBOOK™. For example, SPOTIFY™ may allow user 102 to share playlists with user 102's FACEBOOK™ friends and suggest local bands based on user 102's personal information associated with her FACEBOOK™ account. To provide these features, however, application server 104 may require access to user 102's resources that are managed on a FACEBOOK™ resource server, such as resource server 106, for example.

Application 105 may access user 102's resources 107 managed by resource server 106 according to various techniques. For example, user 102 may simply provide application 105 with the credentials to access resources 107 on resource server 106. This approach, however, presents various drawbacks. For example, by providing these credentials, user 102 is granting application 105 wide-ranging access to her resources 107, which may allow application 105 to perform actions beyond those agreed to or anticipated by user 102. Further, use of such an approach may leave the user 102's credentials vulnerable to unauthorized detection, for example due to a compromise in the security of application server 104.

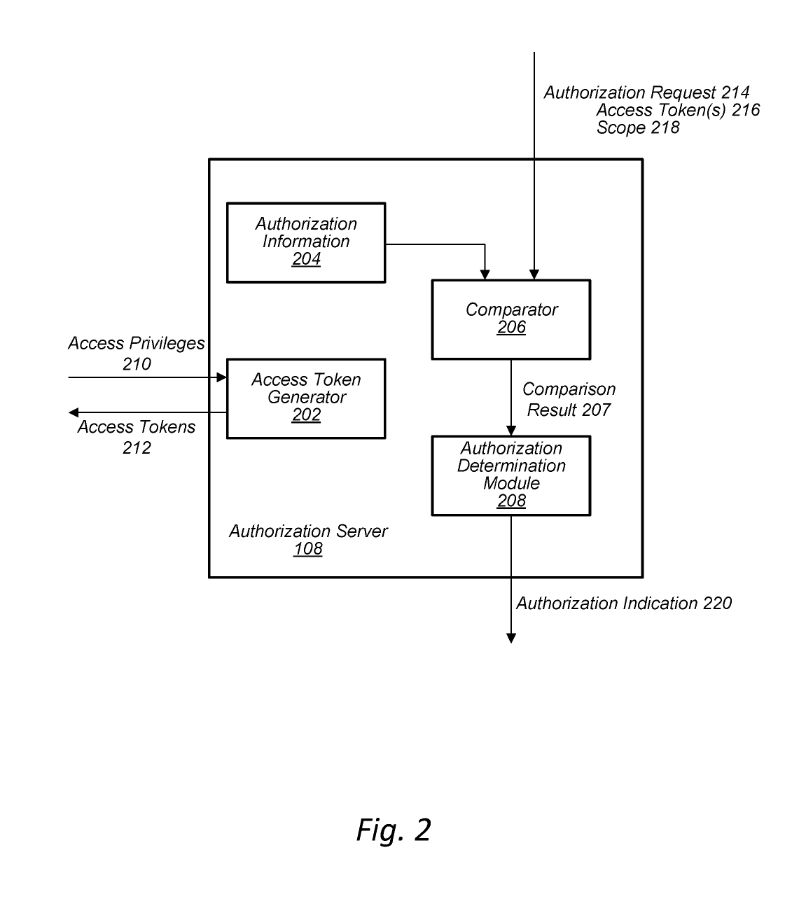

Alternatively, resource server 106 may implement an authorization framework, such as OAuth 2.0, to provide application 105 with more limited access to resources 107. In various embodiments, such an authorization framework may be implemented, for example, using authorization server 108. For example, resource server 106 may delegate the process of authorizing the access requests that it receives (e.g., from application 105) to authorization server 108. Note that, although resource server 106 and authorization server 108 are shown separately in FIG. 1, in various embodiments, resource server 106 may be configured to perform some or all of the functionality of authorization server 108, described in more detail with reference to FIG. 2. Further, note that, in some embodiments, a single authorization server 108 may perform authorization services for various resource servers 106.

Authorization server 108 may implement an authorization framework, in some embodiments, by provisioning an access token to application 105. As used herein, “access token” is to be understood according to its ordinary meaning in the art, which includes a string representing an authorization credential used to access protected resources. One of ordinary skill in the art with the benefit of this disclosure will recognize that an access token may take various formats. For example, in some embodiments, an access token may indicate an identifier that may be used to retrieve authorization information. In other embodiments, however, an access token may self-contain authorization information. In some embodiments, the access token may specify the scope and duration of access to the resource server permitted by the access token. For instance, continuing with the example above, an access token provisioned to SPOTIFY™ may specify that the token permits the application server 104 to access resources 107 managed by resource server 106 for a duration of one week. Once it receives this access token, application 105 may send access requests, along with the access token, to resource server 106, requesting access to one or more of user 102's resources 107. In response to these access requests, resource server 106 may send an authorization request, which may include the received access token, to authorization server 108. Authorization server 108 may then determine whether to authorize the authorization request based on the received access token.

The systems and methods described herein contemplate the provision of multiple access tokens that correspond to a reduction of application 105's access to resource server 106 over time. This approach allows, in response to a single access request, provisioning of a suite of access tokens, at least some of which vary in scope and duration from one another. (While application 105 and application server 104 are distinct, references may be made herein to either application 105's or application server 104's access to resources 107.) In various embodiments, resources 107 may be protected resources that, as noted above, require user 102's authorization to be accessed. As shown in FIG. 1, user 102 may authorize application 105 to make such access by sending information indicative of a grant of access privileges to authorization server 108 that authorizes application 105 to access resources 107. Further, in some embodiments, the grant of access privileges may specify the types of access application 105 is permitted to make and the authorized duration for each type of access. For example, user 102 may send a grant of access privileges to authorization server 108 that authorizes application 105 to access user 102's contact list for a duration of one week and user 102's location information for a duration of one day. Note that, in some embodiments, the information indicative of the grant of access privileges may instead be sent from user 102 to resource server 106 or application 105, rather than to authorization server 108. Further, note that, in some embodiments, prior to receiving the grant of access privileges, information specifying the grant of access privileges may be sent to user 102, for example by authorization server 108, application 105, resource server 106, etc. In such embodiments, the information specifying the grant of access privileges may include the types of access request by the application and the corresponding durations for each of the types of access that are requested by application 105.

In various embodiments, authorization server 108 may provision a plurality of access tokens to application 105 corresponding user 102's grant of access privileges. In some embodiments, each of the plurality of access tokens may authorize a particular scope of access to resources 107 for a particular duration. For example, authorization server 108 may provision two access tokens to application 105, one authorizing application 105 to access user 102's contact list for a duration of one week and one authorizing application 105 to access user 102's location information for a duration of one day. In some embodiments, authorization server 108 may store authorization information associated with the grant of access privileges. In some embodiments, for example, this authorization information may include, for each of the plurality of access tokens, a particular scope of access to the resources of user 102 that are managed by resource server 106 and a corresponding duration that is based on that particular scope of access. As shown in FIG. 1, subsequent to receiving the plurality of access tokens, application 105 may send one or more access requests, including one or more of the plurality of access tokens, to resource server 106, requesting to access one or more resources 107 of user 102 managed by resource server 106. For instance, application 105 may send an access request to resource server 106 attempting to access user 102's location information and contact list. Further, this request may include both of the access tokens provisioned to application 105 by authorization server 108. Resource server 106 may then send an authorization request corresponding to the access request to authorization server 108. In some embodiments, the authorization request may include the one or more access tokens received from application 105.

In various embodiments, authorization server 108 may be configured to determine whether to authorize the authorization request based on the stored authorization information. In some embodiments, for example, authorization server 108 may compare the received one or more access tokens to the plurality of access tokens provisioned to application 105. Further, in response to detecting that one or more of the received access tokens match one or more of the provisioned access tokens, authorization server 108 may determine whether a type of the access request is permitted by the scope of the matched access tokens. For example, authorization server 108 may detect that the two access tokens received from resource server 106 match the two access tokens provisioned to application 105 for user 102. In response to this detection, authorization server 108 may determine whether the types of access requested by application 105 are permitted by the particular scope of the provisioned access tokens. In the described example, in which application 105 attempts to access user 102's contact list and location information, authorization server 108 may determine that the types of access included in the one or more access requests are permitted by the scopes of the provisioned access tokens. Further, in various embodiments, authorization server 108 may be configured to determine whether the received one or more access tokens have expired for the type of access requested. For example, authorization server 108 may be configured to determine, based on the duration of the provisioned access tokens, whether the two access tokens sent by application 105 have expired for their respective types of access. That is, in this example, authorization server 108 may determine whether the received access token corresponding to accessing user 102's contact list has expired based on the stored authorization information for the provisioned access token corresponding to accessing user 102's access list. Similarly, authorization server 108 may determine whether the received access token corresponding to accessing user 102's location information has expired based on the stored authorization information for the provisioned access token corresponding to accessing user 102's location information. After determining whether to authorize the authorization request, authorization server 108 may send an authorization indication to resource server 106. This authorization indication may, in various embodiments, indicate whether the access requests by application server 104 are authorized, partially authorized, or denied.

The disclosed systems and methods for providing varying levels of access over time to resources may provide various improvements to the functioning of system 100 as a whole, including authorization server 108. For example, consider a situation in which the duration of an access token is not based on its corresponding scope of access to a resource server. In such a situation, an access token may have multiple scopes with a single duration. This duration, however, may need to be limited to a time period that is appropriate for the most sensitive type of access permitted by the scopes. Thus, in such a situation, the access tokens provisioned may expire more quickly, resulting in an increased number of requests to users for authorization credentials and an increased number of requests to the authorization server for access tokens. Conversely, if the single duration is not limited and instead authorizes access to all of the types of access included within the scopes for an extended duration, this may compromise the security of the resources managed by the resource server. The disclosed systems and methods, however, allow for the provisioning of access tokens in which the duration is based on the scope of access, resulting in fewer requests to the authorization server and an improved user experience without compromising the security of the resources managed by the resource server. Further, the disclosed systems and methods may provide increased granularity to the levels of access granted to a third-party application to access resources managed by a resource server. This improved access control may, in turn, provide improved security to the resources managed by the resource server by limiting the duration of access to resources deemed to be more sensitive. Thus, in various embodiments, the disclosed systems and methods may provide various improvements to the functioning of the authorization server, particularly as it relates to securely authorizing access requests by third-party applications.

Turning now to FIG. 2, a block diagram of an example authorization server 108 is shown, according to some embodiments. As shown in FIG. 2, authorization server 108 includes various modules configured to perform designated functions discussed in more detail below.

As used herein, the term “module” refers to circuitry configured to perform specified operations or to physical non-transitory computer readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

In the embodiment depicted in FIG. 2, authorization server 108 includes access token generator 202, authorization information 204, comparator 206, and authorization determination module 208. In various embodiments, authorization server 108 may be configured to determine whether to authorize authorization requests received from resource server 106.

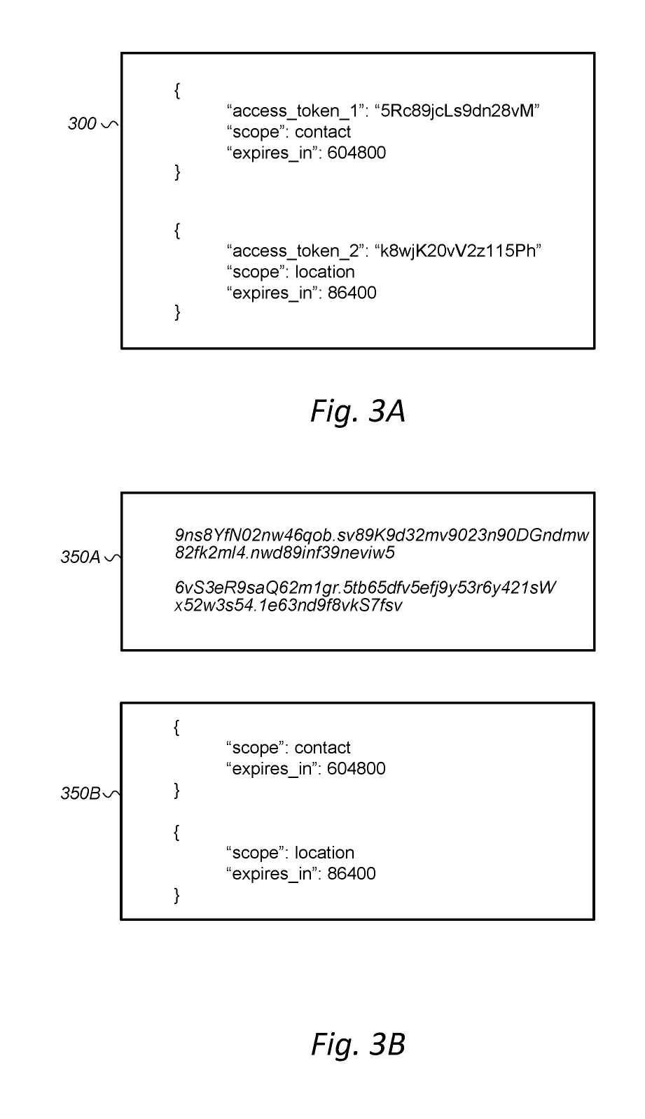

As shown in FIG. 2, authorization server 108 may receive information indicative of a grant of access privileges 210. In some embodiments, the access privileges 210 may be provided, for example, by user 102 of FIG. 1 and may authorize an application 105 hosted by application server 104 to access resources 107 of user 102 managed by resource server 106. Authorization server 108 includes access token generator 202. In various embodiments, access token generator 202 may be configured to generate one or more access tokens 212 corresponding to the grant of access privileges 210. As described in more detail below with reference to FIGS. 3A and 3B, access tokens 212 may be generated in various formats. For example, in one embodiment, the access tokens 212 generated by access token generator 202 may be in the format of an alphanumeric string that authorization server 108 may use as an identifier to store and retrieve authorization information 204 corresponding to the grant of access privileges 210. In various embodiments, authorization server 108 may provision the one or more access tokens 212 to application 105.

Authorization server 108 of FIG. 2 further includes authorization information 204. In various embodiments, authorization server 108 may store authorization information 204 associated with the grant of access privileges 210. In some embodiments, authorization information 204 may include, for each of the access tokens 212 provisioned to application server 104, a particular scope of access to the resources of user 102 managed by resource server 106, and a corresponding duration based on the particular scope of access. For example, in some embodiments, authorization server 108 may store authorization information 204 as part of a table, creating a record for each access token 212 that it provisions, for example to application server 104 and other application servers. In the example of FIG. 1, for instance, authorization server 108 may provision two access tokens 212 to application 105—a first access token that permits application 105 to access user 102's contact list for a duration of one week and a second access token that permits application 105 to access user 102's location information for a period of one day. In such an embodiment, authorization server 108 may store authorization information 204 for the first access token specifying its scope (e.g., access to user 102's contact list) and its duration (e.g., one week). Similarly, authorization server 108 may store authorization information 204 for the second access token specifying its scope (e.g., access to user 102's location information) and its duration (e.g., one day).

As depicted in FIG. 2, authorization server 108 may receive an authorization request 214, for example from resource server 106 of FIG. 1. In various embodiments, authorization request 214 may correspond to an access request by application server 104 to access one or more resources of user 102 that are managed by resource server 106. As shown in FIG. 2, authorization request 214 may include one or more access tokens 216 sent from application server 104 to resource server 106 as part of the access request. In some embodiments, the authorization request 214 may include all of the plurality of access tokens 212 that were provisioned to the application 105. For example, in some embodiments, application 105 may simply send all of the access tokens 212 it has received from authorization server 108 within a given time period (e.g., in the last five minutes, 24 hours, week, etc.). In other embodiments, however, the one or more access tokens 216 included in authorization request 214 may include selected access tokens that correspond to the type of the access request. For example, application 105 may select the one or more access tokens 216, from the provisioned access tokens 212, that correspond to the type(s) of access requested to the resources of resource server 106.

Further, authorization request 214 may specify the scope 218 of the access request by application server 104. That is, in various embodiments, the types of access to resource server 106 requested by application server 104 may be specified by scope 218. For example, application 105 may send an access request to resource server 106 requesting access to user 102's contact list and location information. In that access request, application 105 may include the two access tokens provisioned to it by authorization server 108. After receiving the access request, resource server 106 may then send an authorization request 214 to authorization server 108 that includes the two access tokens 216 (e.g., the first and second access tokens described above, in this particular example) and specify the scope 218 of application 105's access request (e.g., to access user 102's contact list and location information). Note that, in other embodiments, the types of access requested by application server 104 may be otherwise specified in authorization request 214 in any suitable manner (e.g., as part of the access token(s) 216, etc.).

In various embodiments, authorization server 108 may be configured to determine, based on the authorization information 204, whether to authorize the authorization request 214. For example, as shown in FIG. 2, authorization server 108 includes comparator 206, which may be configured to compare the received one or more access tokens 216 to the plurality of access tokens 212 provisioned to application server 104. In one embodiment, for example, comparator 206 may use an alphanumeric string included in a given access token 216 to perform a search of a table storing authorization information 204 corresponding to access tokens 212 provisioned by authorization server 108. Comparator 206 may generate comparison result 207 based on the comparison between the received access tokens 216 and the authorization information 204.

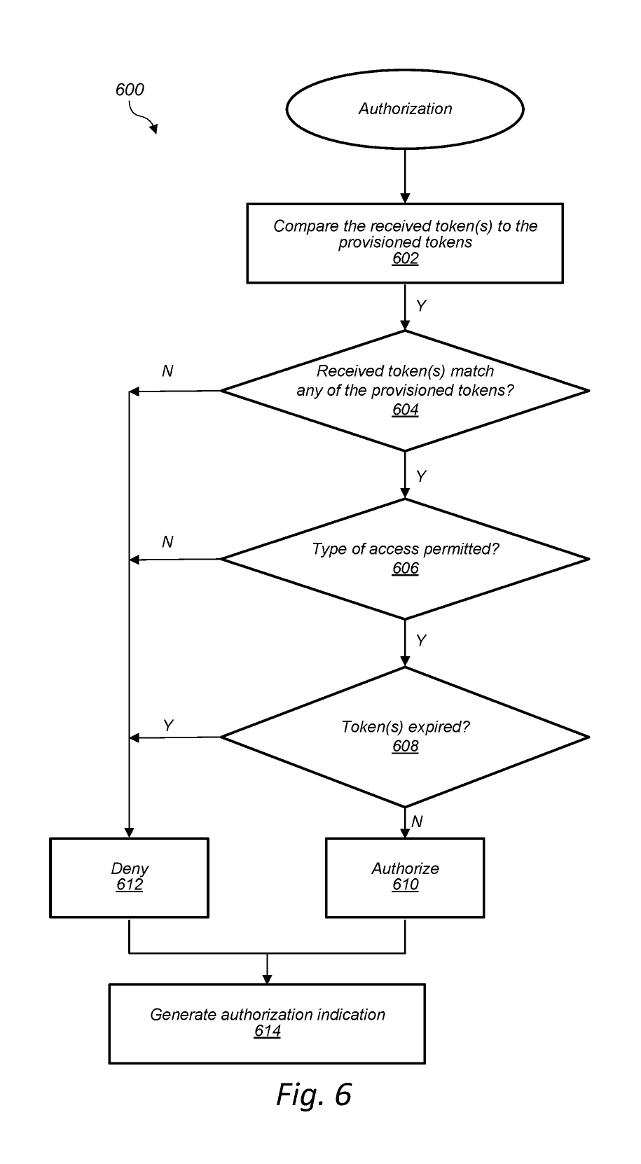

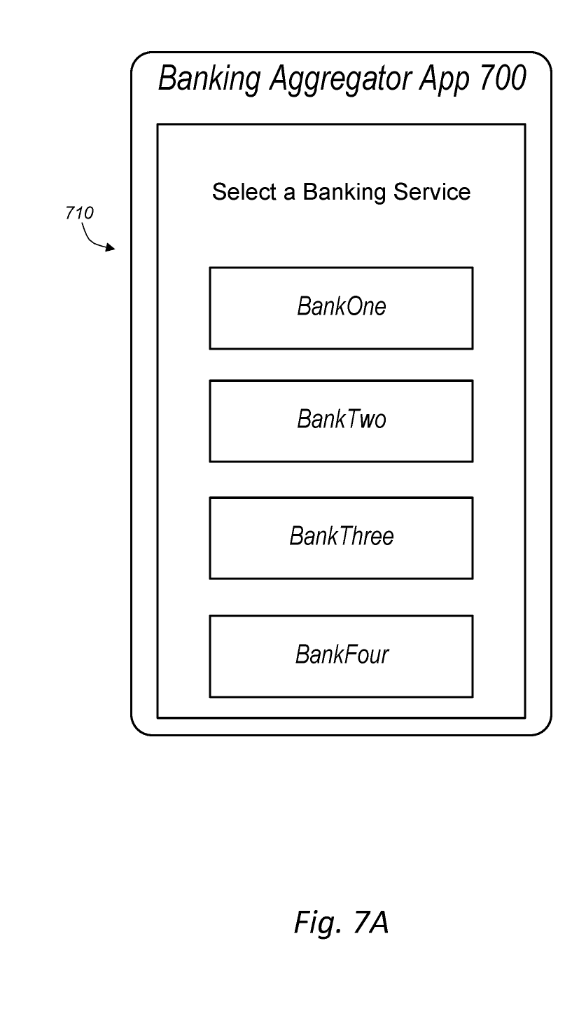

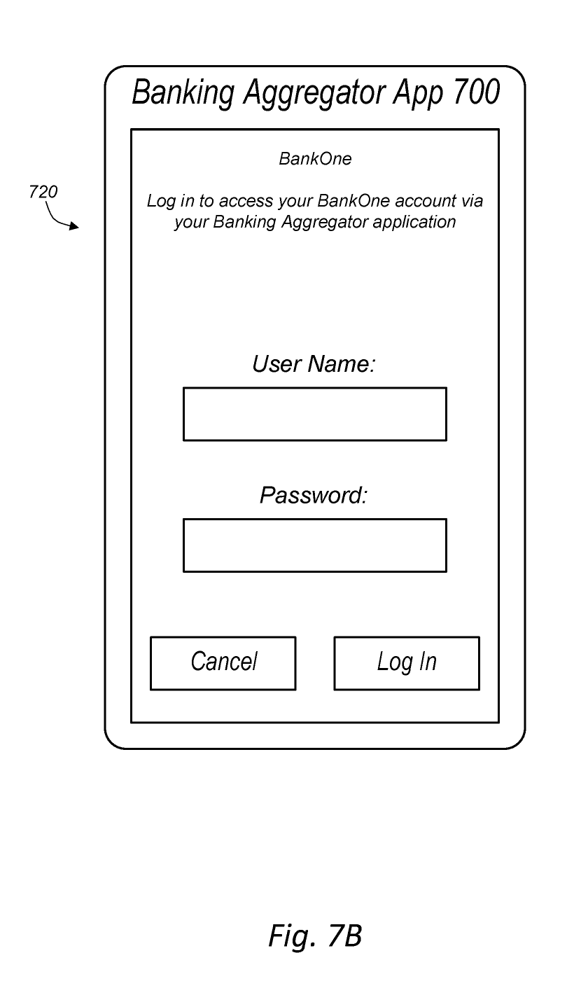

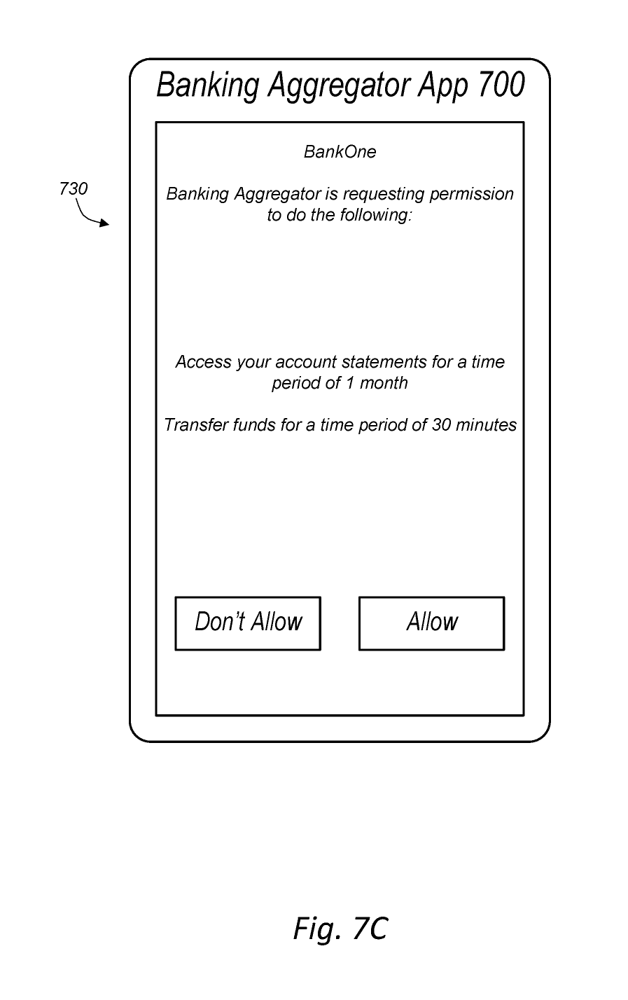

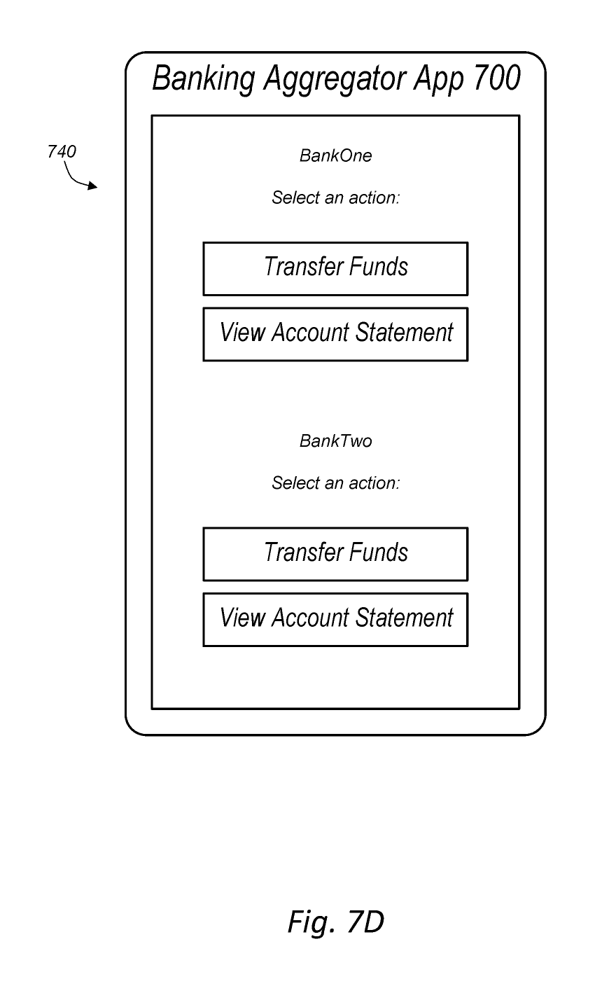

Authorization server 108 further includes authorization determination module 208, which, as described in more detail below with reference to FIGS. 6 and 7, may be configured to determine whether to authorize authorization request 214. For example, in response to detecting that the one or more access tokens 216 match the provisioned access tokens 212, authorization determination module 208 may determine whether the types of access included in the access request, as indicated by scope 218, are permitted by the particular scopes of access tokens 212. Further, authorization determination module 208 may determine, for example based on the authorization information 204 or duration information included with the access tokens 216, whether the access tokens 216 have expired for the types of access requested. Authorization server 108 may then send an authorization indication 220 specifying the result of the authorization determination to the resource server 106. In various embodiments, authorization indication 220 may indicate that authorization request 214 is authorized, partially authorized, or denied. Continuing the above example, for instance, authorization determination module 208 may determine that application 105's request to access user 102's contact list and location information is permitted, based on the received access tokens 216 and the stored authorization information 204. In such an embodiment, authorization server 108 may send authorization indication 220 to resource server 106 specifying that authorization request 214 is authorized.

Referring now to FIG. 3A, an example access token response 300 is shown, according to some embodiments. In various embodiments, access token response 300 may be sent, for example with reference to FIG. 1, as part of an HTTP message from authorization server 108 to provision the multiple access tokens to application server 104. As noted above, access tokens may take various formats. In some embodiments, for example, an access token may be an identifier (e.g., an alphanumeric string) used, for example by authorization server 108, to retrieve authorization information. In the embodiment shown in FIG. 3A, access token response 300 includes two access tokens (e.g., “access_token_1” and “access_token_2”) as identifiers in the format of alphanumeric strings (“5Rc89jcLs9dn28vM” and “k8wjK20vV2z115Ph,” respectively).

Further, access token response 300 specifies, for each of the access tokens, a scope and a corresponding duration. The “scope” parameter of access token response 300 may take various embodiments. For example, in some embodiments, the scope parameter may be in the format of an identifier (e.g., an alphanumeric string) that specifies the resources of a resource server 106 that a bearer (e.g., an application hosted on application server 104) of the associated access token is permitted to access. The syntax used for the scope parameter may vary between resource servers or authorization servers, and may be defined, for example, by the operators of the given authorization server 108, resource server 106, etc. In the embodiment depicted in FIG. 3A, for example, the scope parameter of access_token_1 is specified as “contact.” In the example described above, for instance, a scope of “contact” may indicate that access_token_1 permits application 105 to access the contact list of user 102. Further, in FIG. 3A, the scope of access_token_2 is specified as “location,” which, in this example, may indicate that access_token_2 permits application 105 to access user 102's location information.

Access token response 300 further specifies, for each of the access tokens, a duration (e.g., a time period) during which the corresponding scope of access is authorized. In the depicted embodiment, the duration specified as the “expires_in” parameter expressed in seconds. Note that, although the depicted duration is expressed in terms of seconds, any other suitable units (e.g., milliseconds, etc.) may be used. As shown in FIG. 3A, the duration for access_token_1 is specified as 604,800 seconds (i.e., one week) and the duration for access_token_2 is specified as 86,400 seconds (i.e., one day). Note that, in other embodiments, rather than being expressed as a time period (e.g., 600 seconds), the duration may instead be specified as a particular date and time at which the corresponding access token expires (e.g., Mon, 12 Jun. 2017 08:48:15 GMT).

Referring now to FIG. 3B, an example access token response 350A is shown. As with access token response 300, access token response 350A may be sent, for example, as part of an HTTP message from authorization server 108 to provision the multiple access tokens to application server 104. In access token response 350A, two access tokens are provided. In contrast to the access tokens depicted in FIG. 3A, however, the two access tokens of access token response 350A are provided in a format that self-contains authorization information, rather than as an identifier that may be used by authorization server 108 to retrieve authorization information.

In the depicted embodiment, the access tokens in access token response 350A are provided in a JSON Web Token format, but may also take other suitable forms known in the art. As shown in FIG. 3B, each of the two access tokens provided in access token response 350A includes three encrypted sections separated by periods: a header, a payload, and a signature. When decrypted, for example by authorization server 108, the payload of the access token may include a JSON object specifying one or more parameters associated with the access token. For example, access token response 350B depicts a decrypted version of the payload of the access tokens in access token response 350A. As shown, for the first access token in access token response 350B, the scope is specified as “contact” and the duration, expressed in the expires_in parameter, is specified as 604,800 seconds. Further, for the second access token in access token response 350B, the scope is specified as “location” and the duration, expressed in the expires_in parameter, is specified as 86,400 seconds.

Note that the described access tokens are provided merely as examples and are not intended to limit the scope of this disclosure. One of ordinary skill in the art with the benefit of this disclosure will recognize that access tokens may be implemented in any suitable format without departing from the scope of the present disclosure. Further, any suitable scope or duration may be defined (e.g., by user 102, by the operators of resource server 106, authorization server 108, or application server 104, etc.) for use in various access tokens.

### Example Methods

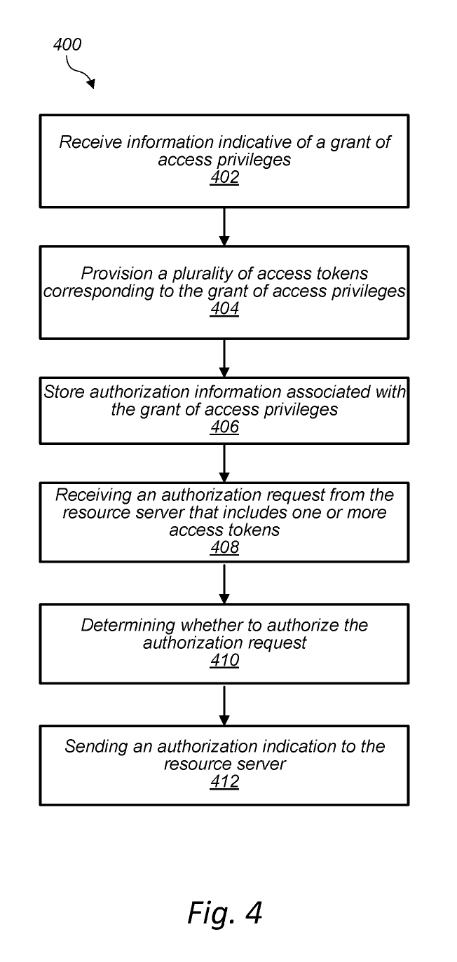

Turning now to FIG. 4, a flow diagram of an example method 400 is shown for authorizing varying levels of access to resources of a resource server, according to some embodiments. In various embodiments, method 400 may be implemented, for example, by authorization server 108 of FIG. 1. FIG. 4 includes blocks 402-412. While the blocks are shown in a particular order for ease of understanding, other orders may be used. Block 402 includes receiving information indicative of a grant of access privileges. In some embodiments, the grant of access privileges may be received by an authorization server and may authorize an application server to access resources of a user that are managed by a resource server. In one embodiment, for example, the grant of access privileges may authorize the application server to perform modification operations for a first duration and perform read operations for a second duration that is longer than the first duration.

Method 400 then proceeds to block 404, which includes provisioning a plurality of access tokens corresponding to the grant of access privileges. In some embodiments, for example, an authorization server 108 may provision the plurality of access tokens to an application 105 executing on an application server 104. In some embodiments, the plurality of access tokens may include a first access token associated with a first scope and a first duration that is based on the first scope. Further, in some embodiments, the plurality of access tokens may include a second access token associated with a second, different scope and a second duration based on the second, different scope. In some embodiments, the second, different scope may be more expansive than the first scope, and the second duration may be shorter than the first duration. For instance, in the example provided above with reference to FIG. 1, the first access token provisioned by authorization server 108 (e.g., to an application 105 hosted on application server 104) may be associated with a scope authorizing application 105 to access user 102's contact list for a duration of one week. Further, the second access token provisioned by authorization server 108 may be associated with a scope authorizing application 105 to access user 102's location information for a duration of one day.

In various embodiments, some type of access to resources 107 (e.g., accessing user 102's location information) may be considered to be more sensitive than other types of access to resources 107 (e.g., accessing user 102's contact list). Accordingly, in some embodiments, one or more entities (e.g., resource server 106, authorization server 108, application 105, user 102, etc.) may define, for the various types of access to resources 107, the corresponding duration for which access is authorized. In some embodiments, authorization server 108 may be configured to provision access tokens with durations that differ based on the expansiveness of their respective scope. For more expansive types of access, as determined by one or more of the entities noted above, authorization server 108 may provision access tokens with shorter durations. Conversely, for types of access that are relatively less expansive, authorization server 108 may provision access tokens with longer durations.

Method 400 then proceeds to block 406, which includes storing authorization information associated with the grant of access privileges. For example, in some embodiments, the authorization server may store authorization information that includes, for each of the plurality of provisioned access tokens, a particular scope of access to the resources of the user that are managed by the resource server, and a corresponding duration based on the particular scope of access.

Method 400 then proceeds to block 408, which includes receiving an authorization request from the resource server that includes one or more access tokens. As depicted in FIG. 1, for example, authorization server 108 may receive an authorization request from resource server 106, where the authorization request corresponds to an access request sent by application server 104 to access one or more resources 107 of user 102 that are managed by resource server 106. Further, in various embodiments, the authorization request may include one or more access tokens sent by application server 104. For example, in one embodiment, the authorization request may include a first access token associated with a first scope and a first duration based on the first scope, and a second access token associated with a second, different scope and a second different duration based on the second, different scope. In some embodiments, the second, different scope may be more expansive than the first scope.

Method 400 then proceeds to block 410, which includes determining, by the authorization server, whether to authorize the authorization request sent by the resource server. As explained in more detail below with reference to FIG. 6, authorization server 108 may determine whether to authorize the authorization request based both on the stored authorization information and the received one or more access tokens included with the authorization request. Method 400 then proceeds to block 412, which includes sending an authorization indication from authorization server 108 to resource server 106. This authorization indication, as discussed in more detail below with reference to FIG. 6, may indicate that the authorization request is authorized, partially authorized, or denied.

Note that various ones of blocks 402-412 in method 400 may be repeated to provide varying levels of access to resources 107 of a resource server 106. In some embodiments, block 408 may include authorization server 108 receiving a subsequent authorization request, including the first and second access tokens, associated with a subsequent access request by application server 104. For example, the subsequent access request may be made by the SPOTIFY™ application to access user 102's FACEBOOK™ contact list and location information. In such embodiments, authorization server 108 may determine at block 410 whether to access this subsequent authorization request, as discussed in more detail below with reference to FIG. 6, and send an authorization indication to resource server 106 at block 412. For example, in one embodiment, authorization server 108 may determine that the subsequent authorization request is denied by detecting that the first and second received access tokens 216 respectively match first and second provisioned access tokens 212 and determining that the corresponding durations for both the first and second access tokens 216 have expired.

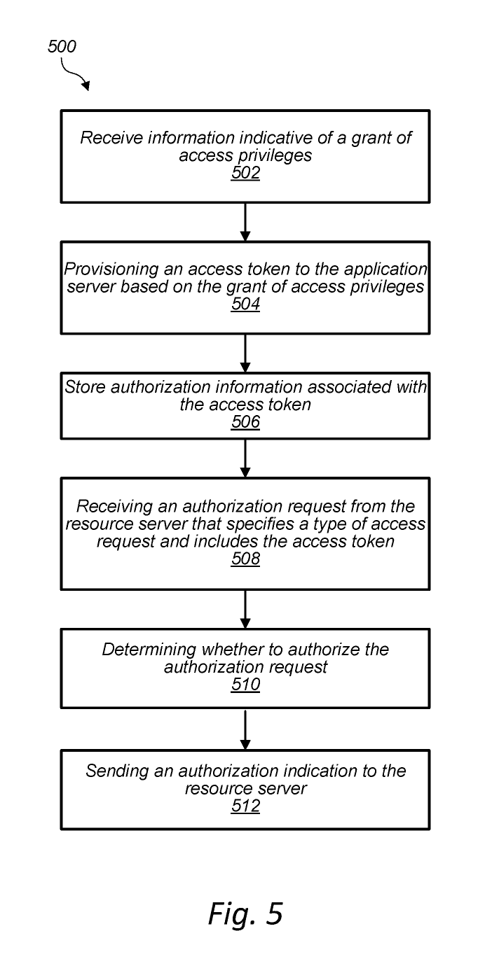

Referring now to FIG. 5, a flow diagram of an example method 500 is shown for authorizing varying levels of access to resources of a resource server, according to some embodiments. Method 500 is an alternative to method 400 previously-depicted in FIG. 4. As described in more detail below, method 500 includes provisioning a single access token to an application server based on a grant of access privileges by a user, rather than provisioning a plurality of access tokens as in block 404. In various embodiments, method 500 may be implemented, for example, by authorization server 108 of FIG. 1. FIG. 5 includes blocks 502-512. While the blocks are shown in a particular order for ease of understanding, other orders may be used.

Block 502 includes receiving information indicative of a grant of access privileges, as in block 402. In some embodiments, the grant of access privileges may include a first access privilege authorizing a first type of access to the resource server for a first duration and a second access privilege authorizing a second type of access to the resource server for a second duration. Method 500 then proceeds to block 504, which includes provisioning, by the authorization server to the application server, an access token based on the grant of access privileges. For example, in some embodiments, authorization server may provision a single access token 212 to application server 104, which authorizes application 105 to perform the first type of access for the first duration and the second type of access for the second duration.

Method 500 then proceeds to block 506, which includes storing authorization information associated with the access token. In some embodiments, for example, authorization server 108 stores authorization information 204 specifying that the first type of access to the resource server 106 is authorized for the first duration and that the second type of access to the resource server 106 is authorized for the second duration.

Method 500 then proceeds to block 508, which includes receiving an authorization request 214 from the resource server 106 that specifies the type(s) of access requested and includes the access token 216. In contrast to block 408 of FIG. 4, in various embodiments, block 508 includes receiving the single access token 212 provisioned to the application server 104. In some embodiments, the access request by application server 104 may include a request to perform a first type of access and a second type of access, such as accessing user 102's contact list and location information, for example. In some embodiments, the second type of access to resource server 106 may be more expansive than the first type of access, and the second duration may be shorter than the first duration.

Method 500 then proceeds to block 510, which includes determining, by the authorization server, whether to authorize the authorization request sent by the resource server. As described in more detail below with reference to FIG. 6, the authorization server 108 may determine whether to authorize the authorization request 214 by accessing the stored authorization information 204 associated with the received access token 216, determining whether the type(s) of access requested by application 105 are permitted by user 102's grant of access privileges, and determining whether the received access token 216 has expired. Method 500 then proceeds to block 512, in which the authorization server sends an authorization indication to the resource server. The authorization indication may indicate that the authorization request 214 is authorized, partially authorized, or denied.

Note that various ones of blocks 502-512 in method 500 may be repeated to provide varying levels of access to resources 107 of a resource server 106. In some embodiments, block 508 may include authorization server 108 receiving, from resource server 106, a subsequent authorization request associated with a subsequent access request by the application server 104, which may include a request to perform a first type of access and a second type of access. In various embodiments, authorization server 108 may determine at block 510 whether to authorize this subsequent authorization request, as discussed in more detail below with reference to FIG. 7, and, at block 512, send an authorization indication to resource server 106. In one embodiment, for example, authorization server 108 may determine that the subsequent authorization request is partially authorized based on a determination that, for the second type of access, but not the first type of access, the access token has expired. Further, in some embodiments, authorization server 108 may determine that the subsequent authorization request is denied based on a determination that, for both the first type of access and the second type of access, the access token has expired.

Turning now to FIG. 6, a flow diagram is shown of an example method 600 for authorizing access to a resource server, according to some embodiments. In various embodiments, method 600 may be implemented as part of block 410 of FIG. 4 or block 510 of FIG. 5. FIG. 6 includes blocks 602-614. While the blocks are shown in a particular order for ease of understanding, other orders may be used. Block 602 includes comparing one or more access tokens received from a resource server to access tokens provisioned to an application executing on an application server. For example, comparator 206 may compare an identifier (e.g., an alphanumeric string) included in a given access token 216 with access tokens included in authorization information 204.

Method 600 then proceeds to block 604, which includes determining whether the received access tokens match any of the provisioned access tokens. For example, authorization server 108 may determine whether any of the received access tokens 216 match any of the access tokens 212 provisioned to application 105. If no match is detected at block 604, method 600 continues to block 612, which includes denying the authorization request.

If, however, a match is detected at block 604, method 600 continues to block 606, which includes determining whether the type of access requested by the application is permitted. For example, the authorization determination module 208 may compare the scope 218 specified by the authorization request 214 with the scope of the access token(s) 212 matched at block 604, which may be stored as part of the authorization information 204. If the authorization determination module 208 determines that the type of access requested by application 105, as specified by scope 218, is not within the scope of access authorized by the provisioned access tokens 212, method 600 continues to block 612. If, however, the type of access is permitted by the matched access token(s), method 600 continues to block 608.

Block 608 includes determining, for example by authorization determination module 208, whether the received one or more access tokens 216 have expired. In some embodiments, this determination may include calculating a time period from which the access token(s) 212 were provisioned to the application 105 until a time that the authorization request 214 was received by the authorization server 108. This calculated time period may then be compared to the duration information for access tokens 212 included in authorization information 204 to determine whether the one or more access tokens 216 have expired.

Note, however, that this manner of determining whether the access token(s) have expired is provided merely as an example and is not intended to limit the scope of the present disclosure. In other embodiments, for example, the authorization server 108 determine whether the access token(s) have expired based on various time periods using, for example, any of the following: a time that the grant of access privileges was sent or received, a time that the access token(s) 212 were provisioned, a time that the application 105 submitted the access request to resource server 106, a time that the resource server 106 received the access request or access token(s), a time that the resource server 106 sent the authorization request 214 or access token(s) 216, etc. Further, as noted above, in some embodiments the duration information may be specified as a time that the corresponding access token expires. In such embodiments, authorization server 108 may determine whether the access token(s) have expired by comparing the time specified in the authorization information 204 with the time that the authorization request 214 was sent or received, a time that the access request was sent or received, etc.

If, at block 608, it is determined that the access token(s) have not expired, then method 600 proceeds to block 610, which includes authorizing the authorization request 214. In one embodiment, for example, authorization server 108 may determine that the authorization request 214 is authorized by determining, for example at block 606, that the first type of access and the second type of access are permitted by the grant of access privileges, and determining, for example at block 608, that the access token has not expired for the first type of access and the second type of access. Method 600 then proceeds to block 614, which includes generating an authorization indication that, as shown in block 412 of FIG. 4 or block 512 of FIG. 5, may be sent to resource server 106. In various embodiments, if an authorization request 214 is authorized at block 610, the authorization indication generated at block 614 may specify that the authorization request is authorized. Further, if an authorization request 214 is denied at block 612, the authorization indication generated at block 614 may indicate that the authorization request 214 is denied. For example, authorization server 108 may send an authorization indication specifying that the authorization request is denied in response to determining that the received one or more access tokens 216 have expired, or in response to determining that the type of access requested by application 105 is not permitted by the scope of access of any of the plurality of access tokens 212 provisioned to the application server 104.

In some embodiments, authorization server 108 may determine that an authorization request 214 is both partially authorized and partially denied. That is, a given authorization request 214 may be both authorized at block 610 with regard to one type of access request and denied at block 612 with regard to a different type of access request. For example, with reference to method 400, consider the embodiment in which an authorization request 214 includes first and second received access tokens 216 and a scope 218 that specifies a first and second type of access requested to resources 107. In this example, the authorization request 214 may be partially authorized and partially denied based on authorization server 108: detecting (e.g., at block 604) that one of the first and second received access tokens 216 do not match any of the provisioned access tokens 212, determining (e.g., at block 606) that one of the first or second type of access requested is not permitted by the scope of the corresponding access token 212, determining (e.g., at block 608) that one of the first and second received access tokens 216 have expired, or any combination thereof. In one embodiment, for example, authorization server 108 may determine that the authorization request 214 is partially authorized by detecting, for example at block 604, that the first and second received access tokens 216 match first and second provisioned access tokens 212 and determining, for example at block 608, that the duration for the second access token, but not the first access token, has expired. In such an embodiment, authorization server 108 may both authorize the authorization request with respect to the first access token and deny the authorization request with respect to the second access token.

As a further example, consider, with reference to method 500, an embodiment in which an authorization request 214 includes an access token 216 and a scope 218 specifying that the access request includes a request to perform a first and second type of access to resources 107. In some embodiments, the second type of access may be more expansive than the first type of access, and the second duration may be shorter than the first duration. In this example, the authorization request 214 may be partially authorized and partially denied based on authorization server 108 determining (e.g., at block 606) that one of the first or second types of access requested is not permitted by the scope of the corresponding access token 212, determining (e.g., at block 608) that the received access token 216 has expired for one of the first or second types of access requested, etc. In such an embodiment, the authorization indication generated at block 614 may indicate that authorization request 214 is partially authorized and partially denied.

Turning now to FIGS. 7A-7D, an example implementation of an application utilizing resources managed by a resource server is depicted, according to some embodiments.

In FIG. 7A, an example application (“Banking Aggregator App 700”) is shown. In various embodiments, Banking Aggregator App 700 may be, for example, application 105 hosted by application server 104 of FIG. 1. In the embodiment depicted in FIGS. 7A-7D, Banking Aggregator App 700 may be a third-party application 105 that allows a user 102 to access resources 107 managed by resource servers 106 of multiple different banks. For example, in some embodiments, Banking Aggregator App 700 may be operable to access resources 107 that include viewing account statements for and making payment transactions from user 102's bank accounts with various banks (e.g., BankOne, BankTwo, BankThree, BankFour, etc.).

As shown in FIG. 7A, Banking Aggregator App 700 may provide, for example to user 102, an interface 710 that allows user 102 to select a banking service to access via the Banking Aggregator App 700. Using interface 710, user 102 may select a bank (e.g., BankOne) at which she has a bank account to, for example, view account statements or make payment transactions.

Once user 102 selects a bank on interface 710, an interface 720, depicted in FIG. 7B, may be provided that requests user 102 to enter login credentials (e.g., username and password) for user 102's bank account with BankOne. Interface 720 may be provided by different entities in various embodiments, such as application server 104, authorization server 108, resource server 106, etc. For example, in some embodiments, in response to user 102 selecting “BankOne” on interface 710, Banking Aggregator App 700 may determine whether it has any valid (e.g., not expired) access tokens for user 102 for BankOne. If Banking Aggregator App 700 determines that it does not have any valid access tokens for BankOne, Banking Aggregator App 700 may redirect (e.g., via a redirect URL) user 102 to authorization server 108, which may provide information to and request credentials from user 102 through interface 720. For example, after verifying user 102's credentials, authorization server 108 may provide user 102 with interface 730 depicted in FIG. 7C. As shown in FIG. 7C, authorization server 108 may send user 102 information specifying the access privileges requested by Banking Aggregator App 700, including the types of access requested by Banking Aggregator App 700 and the corresponding duration for each of the types of access requested.

In the depicted embodiment, by selecting the “allow” button on interface 730, user 102 may send a grant of access privileges to authorization server 108 that authorizes Banking Aggregator App 700 to access resources 107 of user 102 managed by one or more resource servers 106 associated with BankOne. After receiving the grant of access privileges from user 102, authorization server 108 may, as described above, provision a plurality of access tokens to Banking Aggregator App 700. For example, in the depicted embodiment, authorization server 108 may provision two access tokens to Banking Aggregator App 700: a first access token that permits Banking Aggregator App 700 to access user 102's account statements with BankOne for a duration of one month, and a second access token that permits Banking Aggregator App 700 to transfer funds from user 102's BankOne bank account for a duration of thirty minutes.

User 102 may select additional banking services to access via the Banking Aggregator App 700, for example by repeating the process described above with reference to FIGS. 7A-7C. For example, in the depicted embodiment, user 102 may further select BankTwo to access via Banking Aggregator App 700 using interface 710, provide credentials (e.g., username and password) for user 102's bank account with BankTwo using interface 720, and send a grant of access privileges to an authorization server 108 associated with BankTwo using interface 730. Further, the authorization server 108 associated with BankTwo may provision two access tokens to Banking Aggregator App 700: a third access token that permits Banking Aggregator App 700 to access user 102's account statements with BankTwo for a duration of one month, and a fourth access token that permits Banking Aggregator App 700 to transfer funds from user 102's BankTwo bank account for a duration of thirty minutes.

In some embodiments, the same authorization server 108 may perform authorization services for both BankOne' s resource servers and BankTwo' s resource servers. Note, however, that in various embodiments, BankOne and BankTwo may use separate or unassociated authorization servers 108. That is, the disclosed systems and methods do not require that different resource servers, such as those operated by BankOne and BankTwo, use the same authorization server to authorize their respective access requests. Further, note that although the scope and duration of the access tokens provisioned by the authorization server 108 associated with BankTwo are the same as the access tokens provisioned by the authorization server 108 associated with BankOne, this embodiment is provided merely as an example and is not intended to limit the scope of the present disclosure. In other embodiments, for example, the scope or duration of the access tokens provisioned by various authorization servers 108 may vary (e.g., based on a set of policy rules of the authorization servers 108, the resource servers 106, application 105, user 102, etc.).

After access tokens have been provisioned to Banking Aggregator App 700 for BankOne and BankTwo, user 102 may use Banking Aggregator App 700 to access resources 107 managed by resource servers associated with either BankOne or BankTwo. For example, immediately after the access tokens are provisioned, Banking Aggregator App 700 has access tokens that permit it to access user 102's account statements for one month and make payment transactions from user 102's bank accounts for thirty minutes. User 102 may then make payment transactions via Banking Aggregator App 700, for example by transferring $100 from her account at BankOne to her account at BankTwo. After thirty minutes, however, user 102 will no longer be able to make such payment transactions using Banking Aggregator App 700 as the access tokens that permit that operation have expired. In such situations, Banking Aggregator App 700 will be required to acquire a new access token associated with making payment transactions, as discussed with reference to FIGS. 7A-7C. After thirty minutes, however, user 102 will continue to be able to view account statements for BankOne and BankTwo via Banking Aggregator App 700 as the access tokens that permit that operation have not yet expired.

### Example Computer System

Turning now to FIG. 8, a block diagram of an example computer system 800, which may implement one or more computer systems, such as authorization server 108 of FIG. 1, is depicted. Computer system 800 includes a processor subsystem 820 that is coupled to a system memory 840 and I/O interfaces(s) 860 via an interconnect 880 (e.g., a system bus). I/O interface(s) 860 is coupled to one or more I/O devices 870. Computer system 800 may be any of various types of devices, including, but not limited to, a server system, personal computer system, desktop computer, laptop or notebook computer, mainframe computer system, server computer system operating in a datacenter facility, tablet computer, handheld computer, workstation, network computer, a consumer device such as a mobile phone, music player, or personal data assistant (PDA). Although a single computer system 800 is shown in FIG. 8 for convenience, computer system 800 may also be implemented as two or more computer systems operating together.

Processor subsystem 820 may include one or more processors or processing units. In various embodiments of computer system 800, multiple instances of processor subsystem 820 may be coupled to interconnect 880. In various embodiments, processor subsystem 820 (or each processor unit within 820) may contain a cache or other form of on-board memory.

System memory 840 is usable to store program instructions executable by processor subsystem 820 to cause system 800 perform various operations described herein. System memory 840 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 800 is not limited to primary storage such as system memory 840. Rather, computer system 800 may also include other forms of storage such as cache memory in processor subsystem 820 and secondary storage on I/O Devices 870 (e.g., a hard drive, storage array, etc.). In some embodiments, these other forms of storage may also store program instructions executable by processor subsystem 820.

I/O interfaces 860 may be any of various types of interfaces configured to couple to and communicate with other devices, according to various embodiments. In one embodiment, I/O interface 860 is a bridge chip (e.g., Southbridge) from a front-side to one or more back-side buses. I/O interfaces 860 may be coupled to one or more I/O devices 870 via one or more corresponding buses or other interfaces. Examples of I/O devices 870 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 870 includes a network interface device (e.g., configured to communicate over WiFi, Bluetooth, Ethernet, etc.), and computer system 800 is coupled to a network via the network interface device.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, if an authorization server provisions four access tokens, the terms “first access token” and “second access token” can be used to refer to any two of the four access tokens, and not, for example, just a first two access tokens to be generated, received, etc.

When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, at an authorization server, information indicative of a grant of access privileges by a user to an application server, wherein the grant of access privileges authorizes the application server to access resources of the user managed by a resource server;
provisioning, by the authorization server to the application server, a plurality of access tokens corresponding to the grant of access privileges;
storing, by the authorization server, authorization information associated with the grant of access privileges, including, for each of the plurality of access tokens:
a particular scope of access to the resources of the user managed by the resource server; and
a corresponding duration based on the particular scope of access;
receiving, at the authorization server from the resource server, an authorization request corresponding to an access request by the application server to access one or more resources of the user managed by the resource server, wherein the authorization request includes one or more access tokens;
determining, by the authorization server based on the authorization information, whether to authorize the authorization request, including by:
comparing the received one or more access tokens to the plurality of access tokens provisioned to the application server;
in response to detecting that the received one or more access tokens match a provisioned access token, determining whether a type of the access request is permitted by the particular scope of the provisioned access token; and
determining, based on the corresponding duration of the provisioned access token, whether the received one or more access tokens have expired for the type of the access request; and
sending, by the authorization server, an authorization indication to the resource server.

2. The method of claim 1, wherein the plurality of access tokens include:
a first access token associated with a first scope and a first duration based on the first scope; and
a second access token associated with a second, different scope and a second duration based on the second, different scope, wherein the second, different scope is more expansive than the first scope, wherein the second duration is shorter than the first duration; and
wherein the received one or more access tokens include a first received access token and a second received access token.

3. The method of claim 2, further comprising:
determining, by the authorization server, that the authorization request is partially authorized, including by:
detecting that the first and second received access tokens respectively match the first and second access tokens; and
determining that the corresponding duration for the second access token, but not the first access token, has expired.

4. The method of claim 2, further comprising:
receiving, by the authorization server, a subsequent authorization request associated with a subsequent access request by the application server, wherein the subsequent request includes the first and second received access tokens; and
determining, by the authorization server, that the subsequent authorization request is denied, including by:
detecting that the first and second received access tokens respectively match the first and second access tokens; and
determining that the corresponding durations for both the first and second access tokens have expired.

5. The method of claim 1, wherein the authorization request includes receiving all of the plurality of access tokens provisioned to the application server.

6. The method of claim 1, wherein the received one or more access tokens include a selected access token that corresponds to the type of the access request.

7. The method of claim 1, wherein the grant of access privileges authorizes the application server to:
perform modification operations for a first duration; and
perform read operations for a second duration that is longer than the first duration.

8. The method of claim 1, further comprising:
sending, by the authorization server, the authorization indication specifying that the authorization request is denied in response to determining that the received one or more access tokens have expired, that the type of the access request is not permitted by the particular scope of access of any of the plurality of access tokens provisioned to the application server, or both.

9. The method of claim 1, wherein one or more of the plurality of access tokens is a JSON Web Token.

10. A non-transitory, computer-readable medium having instructions stored thereon that are executable by an authorization computer system to perform operations, comprising:
receiving, at the authorization computer system, information indicative of a grant of access privileges by a user to an application, wherein the grant of access privileges authorizes the application to access resources of the user managed by a resource server;
provisioning, by the authorization computer system to the application, a plurality of access tokens corresponding to the grant of access privileges;
storing, by the authorization computer system, authorization information associated with the grant of access privileges, including, for each of the plurality of access tokens:
a particular scope of access to the resources of the user managed by the resource server; and
a corresponding duration based on the particular scope of access;
receiving, at the authorization computer system from the resource server, an authorization request corresponding to an access request by the application to access one or more resources of the user, wherein the authorization request includes a received one or more access tokens;
determining, by the authorization computer system, whether to authorize the authorization request, including by:
comparing the received one or more access tokens to the plurality of access tokens provisioned to the application;
in response to detecting that the received one or more access tokens match a provisioned access token of the plurality of access tokens provisioned to the application, determining whether a type of the access request is permitted by the particular scope of the provisioned access token; and
determining, based on the corresponding duration of the provisioned access token, whether the provisioned access token has expired; and
sending, by the authorization computer system, an authorization indication to the resource server.

11. The non-transitory, computer-readable medium of claim 10, wherein plurality of access tokens provisioned to the application include:
a first access token associated with a first scope and a first duration based on the first scope; and
a second access token associated with a second, different scope and a second duration based on the second, different scope, wherein the second, different scope is more expansive than the first scope, wherein the second duration is shorter than the first duration.

12. The non-transitory, computer-readable medium of claim 11, wherein the received one or more access tokens include a first received access token and a second received access token; wherein the operations further comprise:
determining, by the authorization computer system, that the authorization request is partially authorized, including by:
detecting that the first and second received access tokens respectively match the first and second access tokens; and
determining that the corresponding duration for the second access token, but not the first access token, has expired.

13. The non-transitory, computer-readable medium of claim 12, wherein the operations further comprise:
receiving, by the authorization computer system, a subsequent authorization request associated with a subsequent access request by the application, wherein the subsequent request includes the first and second received access tokens; and
determining, by the authorization computer system, that the subsequent authorization request is denied, including by:
detecting that the first and second received access tokens respectively match the first and second access tokens; and
determining that the corresponding durations for both the first and second access tokens have expired.

14. The non-transitory, computer-readable medium of claim 10, wherein the operations further comprise:
prior to receiving the grant of access privileges, sending, by the authorization computer system to the user, information specifying the grant of access privileges, included the types of access requested by the application and the corresponding durations for each of the types of access requested.

15. A method, comprising:
receiving, at an authorization server, information indicative of a grant of access privileges by a user to an application server, wherein the grant of access privileges authorizes the application server to access resources of the user that are managed by a resource server, wherein the grant of access privileges includes:
a first access privilege authorizing a first type of access to the resource server for a first duration; and
a second access privilege authorizing a second type of access to the resource server for a second duration;
provisioning, by the authorization server to the application server, an access token based on the grant of access privileges;
storing, by the authorization server, authorization information associated with the access token specifying that:
the first type of access to the resource server is authorized for the first duration; and
the second type of access to the resource server is authorized for the second duration;
receiving, by the authorization server from the resource server, an authorization request associated with an access request by the application server, wherein the authorization request specifies a type of the access request and includes the access token;
determining, by the authorization server, whether to authorize the authorization request, including by:
accessing, based on the access token, the stored authorization information associated with the access token;
determining whether the type of the access request is permitted by the grant of access privileges; and
determining, based on the type of the access request, whether the access token has expired; and
sending, by the authorization server, an authorization indication to the resource server.

16. The method of claim 15, wherein the second type of access to the resource server is more expansive than the first type of access; and wherein the second duration is shorter than the first duration.

17. The method of claim 15, wherein the access request by the application server includes a request to perform the first type of access and the second type of access.

18. The method of claim 17, further comprising:
determining, by the authorization server, that the authorization request is authorized, including by:
determining that the first type of access and the second type of access are permitted by the grant of access privileges; and
determining that, for the first type of access and the second type of access, the access token has not expired.

19. The method of claim 18, further comprising:
receiving, by the authorization server from the resource server, a subsequent authorization request associated with a subsequent access request by the application server, wherein the subsequent access request includes a request to perform the first type of access and the second type of access; and
determining, by the authorization server, that the subsequent authorization request is partially authorized based on a determination that, for the second type of access but not the first type of access, the access token has expired.

20. The method of claim 17, wherein the receiving information indicative of the grant of access privileges includes:
receiving the first access privilege authorizing a banking aggregator application hosted on the application server to view-only access to account information maintained by the resource server, wherein the account information is associated with an account of the user; and
receiving the second access privilege authorizing the banking aggregator application to initiate payment transactions from the account of the user.
